(19) United States
(12) Patent Application Publication
(10) Pub. No.: US 2017/0166364 A1
(43) Pub. Date: Jun. 15, 2017

(54) WATER BOTTLE WITH SELF-CLOSING VALVE

(71) Applicant: Specialized Bicycle Components, Inc., Morgan Hill, CA (US)

(72) Inventor: Ryan C. Jones, Morgan Hill, CA (US)

(21) Appl. No.: 15/115,565

(22) PCT Filed: Jan. 29, 2015
(86) PCT No.: PCT/US2015/013507

§ 371 Date: Jul. 29, 2016

Related U.S. Application Data
(60) Provisional application No. 61/934,278, filed on Jan. 31, 2014.

(51) Int. Cl. B65D 47/20; B67D 3/00; B65D 5/42

(52) U.S. Cl. CPC B65D 47/2031; B65D 5/42; B67D 3/00; B65D 47/04

(57) ABSTRACT

A liquid-dispensing container comprises a housing and a valve member. The housing is adapted to hold a liquid and includes an opening defined by a wall having an inner edge and an outer edge. The valve member has a ledge engaging the outer edge and a cleat engaging the inner edge. The valve member can further include an integral gasket positioned between the ledge and the cleat and deformed in engagement with the wall. The cleat preferably includes a beveled surface. The valve member can be inserted from the outside of the housing and without the need for additional retention members. Specifically, the valve member is secured to the housing by contacting the cleat with the outer edge of the wall, moving the valve member toward the housing such that the cleat passes through the opening, and engaging the cleat with the inner edge of the wall.

### BACKGROUND

The present invention relates generally to water bottles commonly used by athletes for hydration, and more specifically to such water bottles having self-closing valves.

Water bottles are commonly used by athletes and others to hold and dispense liquids, such as water and sports drinks. Water bottles commonly include a body, a cap, and a valve that is movable relative to the cap between open and closed positions. In the open position, liquid can be dispensed from the bottle, and in the closed position, liquid is inhibited from being dispensed from the bottle.

Water bottles valves are frequently in the form of poppet valves including a poppet that can be slid between open and closed positions. Such poppets usually include an engagement portion that facilitates engagement by the user to facilitate opening the valve. In addition to providing a valve function resulting from sliding the poppet between the open and closed positions, some poppets include an additional valve that inhibits the leakage of liquid when the poppet is open. For example, the poppet can include a flexible, self-closing valve, such as the valve disclosed in U.S. Pat. No. 7,784,652, which is hereby incorporated by reference in its entirety. These self-closing valves are commonly secured over an opening in a cap to inhibit flow of liquid from the water bottle. Sometimes these self-closing valves are secured to a non-movable opening (i.e., water bottles without a sliding poppet).

### SUMMARY

The present invention provides a liquid-dispensing container comprising a housing (e.g., a bottle and a cap threaded together) and a valve member. The housing is adapted to hold a liquid in an interior volume and includes an opening defined by a wall having an inner edge and an outer edge. The valve member has a ledge engaging the outer edge of the side wall and a cleat spaced from the ledge and engaging the inner edge of the side wall. The valve member can further include an integral gasket positioned between the ledge and the cleat and deformed in engagement with the wall. In one embodiment, the cleat comprises a plurality of cleats circumferentially spaced from each other. Preferably, the cleat includes a beveled surface that facilitates insertion of the valve member into the housing.

By virtue of this arrangement, the valve member can be inserted from the outside of the housing and without the need for additional retention members. Specifically, the valve member is secured to the housing by engaging the cleat with the outer edge of the wall, moving the valve member toward the housing such that the cleat passes through the opening, and engaging the cleat with the inner edge of the wall. In the event that the valve member includes an integral gasket, the method includes the step of deforming the cleat against the wall. Preferably, the moving step includes deflecting the cleat away from the wall. In the event that the cleat includes a beveled surface, the engaging step includes engaging the beveled surface with the outer edge of the side wall.

Other aspects of the invention will become apparent by consideration of the detailed description and accompanying drawings.

### BRIEF DESCRIPTION OF THE DRAWINGS

FIG. 1 is a perspective exploded view of a water bottle assembly embodying the present invention, including a bottle, a cap, and a valve member.

FIG. 2 is a top perspective view of the cap and valve member from FIG. 1.

FIG. 3 is a bottom perspective view of the cap and valve member from FIG. 1.

FIG. 4 is an exploded perspective view of the cap and valve member from FIG. 1.

FIG. 5 is a section view taken along line 5-5 in FIG. 2.

FIG. 6 is an enlarged section view taken along line 5-5 in FIG. 2.

FIG. 7 is a side view of the valve member from FIG. 4.

FIG. 8 is a section view of the valve member in FIG. 7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

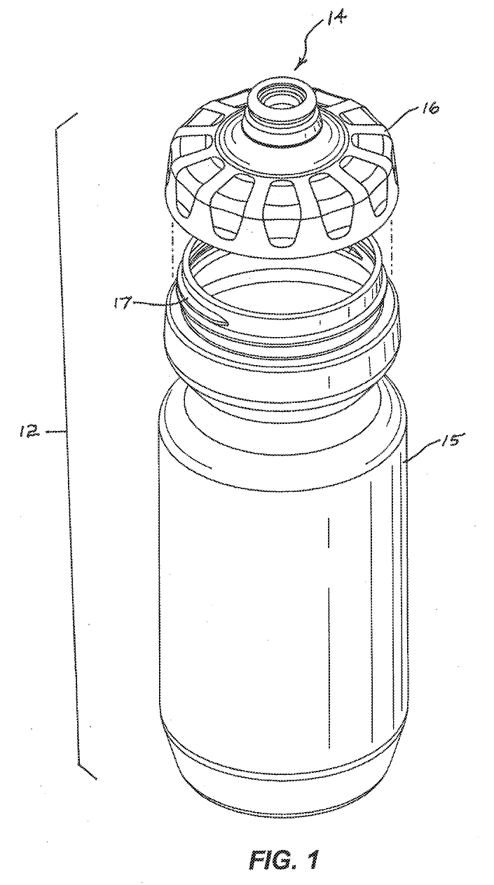

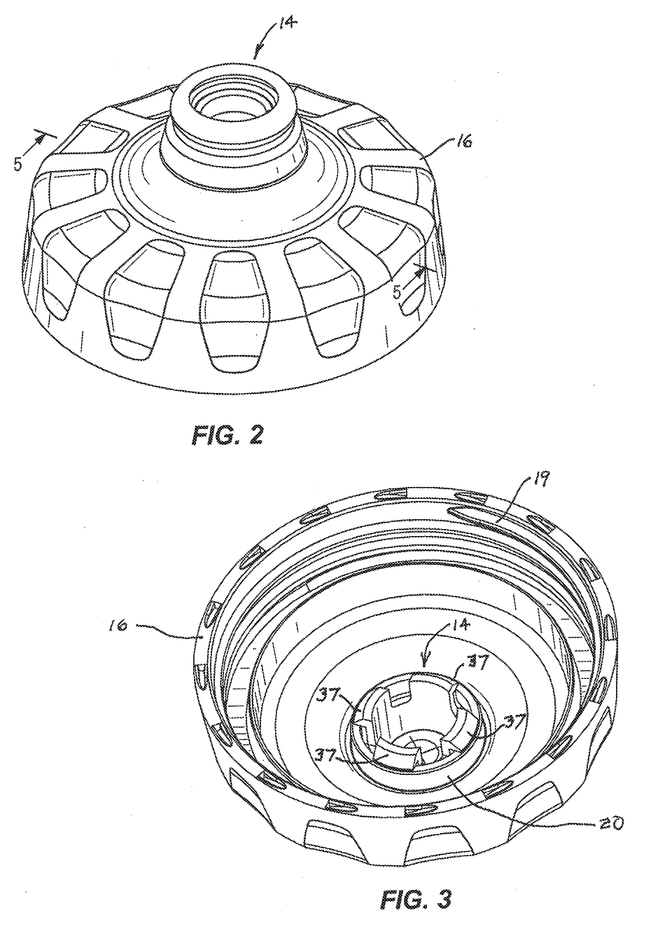

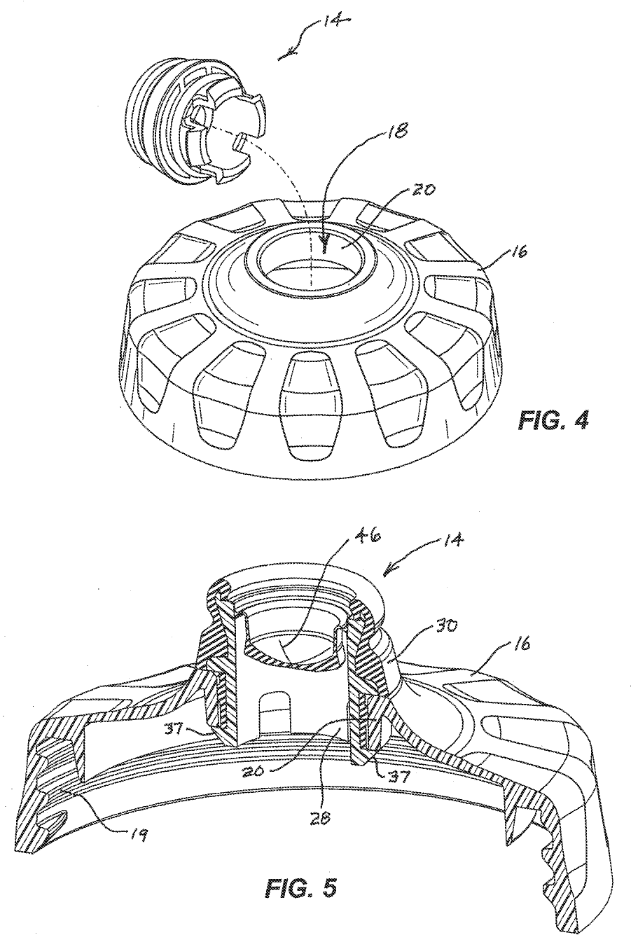

FIGS. 1-4 illustrate a liquid-dispensing container including a housing 12 and a valve member 14. The illustrated housing 12 is formed from a bottle 15 having outer threads 17 and a cap 16 having inner threads 19 threaded onto the bottle 15. Similar constructions are well known in the field of water bottles. The cap 16 includes a central opening 18 defined by a side wall 20 that receives the valve member 14.

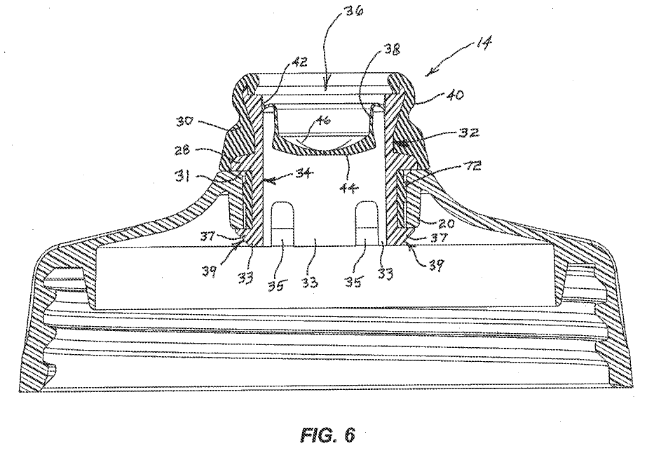

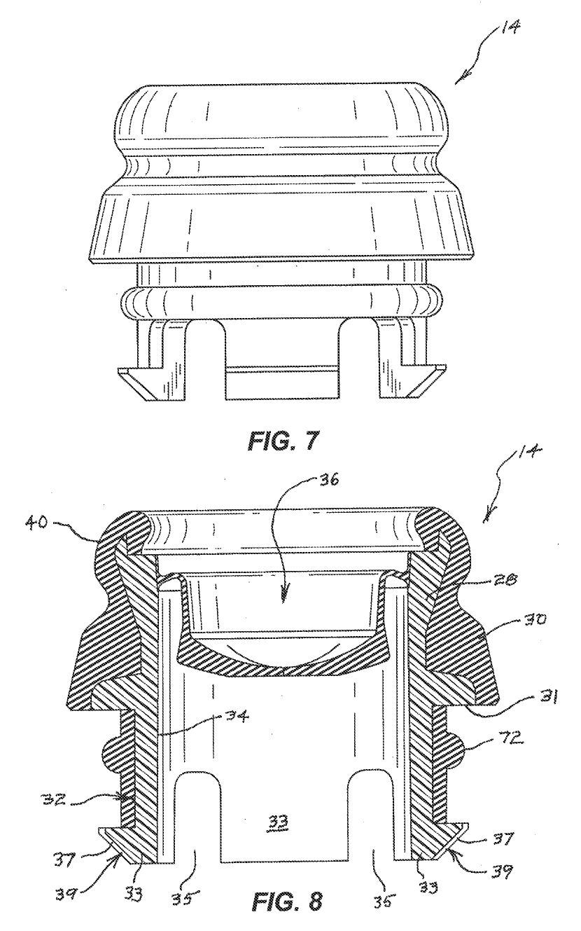

As shown in FIGS. 5, 6, and 8, the valve member 14 includes an inner support 28 and an outer cover 30 co-molded over the inner support 28. The inner support 28 is a tubular structure made from a relatively stiff plastic material having a tensile modulus of elasticity of about 1,450,000 psi. The inner support 28 includes an exterior surface 32 and an interior surface 34 that defines an interior passage 36 that extends all the way through the valve member 14. The inner support 28 has a length that extends almost the entire length of the valve member 14. The exterior surface 32 of the support 28 defines an inner ledge 31. The lower end of the inner support 28 includes four flexible legs 33 separated by recesses 35. The end of each leg 33 includes a cleat 37 that will engage the inner edge of the side wall 20 when the valve member 14 is inserted into the central opening 18. In this position, shown in FIGS. 5-6, the inner ledge 31 engages the outer edge of the side wall 20, thereby securing the valve member 14 in the central opening 18. Each cleat 37 includes a beveled surface 39 that facilitates insertion of the valve member 14 into the central opening 18, as described below in more detail.

The outer cover 30 is co-molded with the inner support 28 using a material having a lower hardness and increased elasticity compared to the inner support 28. In the illustrated embodiment, the outer cover 30 is made from in elastomeric material having a durometer of about Shore A 50 and a tensile modulus of elasticity of about 800 psi. Co-molding the lower density outer cover 30 to the higher density inner support 28 decreases the number of parts required to seal the liquid-dispensing container against leaks, thereby increasing the durability of the valve member 14 of the illustrated embodiment in comparison with prior art valve members. The outer cover 30 includes an inner section 38 and an outer section 40 integrally formed with the inner section 38. The inner section 38 is engaged with and covers a relatively small part of the interior surface 34 of the upper end of the inner support 28. The inner section 38 includes an annular portion 42 that is engaged with and is secured to (e.g., co-molded with) the interior surface 34 of the inner support 28. The inner section 38 further includes a self-closing valve 44 supported by the annular portion 42 and substantially blocking the interior passage 36 through the inner support 28. The self-closing valve 44 includes slits 46 that defined four flaps that will open when sufficient pressure is applied to the valve 44. Self-closing valves of the type illustrated in the figures are well known in the field of water bottles.

The outer section 40 includes an integral gasket 72 positioned between the inner ledge 31 and the cleats 37. The gasket 72 is dimensioned to contact and be compressed against the side wall 20 of the cap 16 in order to provide a watertight seal between the valve member 14 and the cap 16.

In order to assemble the valve member 14 to the cap 16, the valve member 14 is aligned with the central opening 18 of the cap 16 and then the beveled surfaces 39 of the cleats 37 are brought into contact with the outer edge of the side wall 20 of the cap 16. Further movement of the valve member 14 toward the cap 16 results in the cleats 37 flexing slightly inward and/or the sidewall 20 flexing slightly outward to facilitate insertion of the valve member 14 into the central opening 18 of the cap 16. Eventually, the cleats 37 will pass and mechanically lock onto the inner edge of the side wall 20. In this position, the gasket 72 is deformed against the side wall 20 and the valve member 14 is secured in the central opening 18.

Various features and advantages of the invention are set forth in the following claims.

What is claimed is:

1. A liquid-dispensing container comprising:
a housing adapted to hold a liquid in an interior volume, the housing including an opening defined by a wall having an inner edge and an outer edge; and
a valve member having a ledge engaging the outer edge of the wall and a cleat spaced from the ledge and engaging the inner edge of the wall.

2. A liquid-dispensing container as claimed in claim 1, wherein the housing includes a bottle and a separable cap.

3. A liquid-dispensing container as claimed in claim 2, wherein the opening is formed in the cap.

4. A liquid-dispensing container as claimed in claim 2, wherein the cap is threaded to the bottle.

5. A liquid-dispensing container as claimed in claim 1, wherein the valve member further includes an integral gasket positioned between the ledge and the cleat, the gasket being deformed in engagement with the wall.

6. A liquid-dispensing container as claimed in claim 1, wherein the cleat comprises a plurality of cleats circumferentially spaced from each other.

7. A liquid-dispensing container as claimed in claim 1, wherein the cleat includes a beveled surface that facilitates insertion of the valve member into the housing.

8. A method of assembling a liquid-dispensing container comprising:
providing a housing adapted to hold a liquid in an interior volume, the housing including an opening defined by a wall having an inner edge and an outer edge;
providing a valve member having a cleat;
contacting the cleat with the outer edge of the wall;
moving the valve member toward the housing such that the cleat passes through the opening; and
engaging the cleat with the inner edge of the wall.

9. A liquid-dispensing container as claimed in claim 1, wherein the housing includes a bottle and a separable cap, and wherein providing a housing includes attaching the cap to the bottle.

10. A method as claimed in claim 1, wherein the valve member further includes an integral gasket, and wherein the method further comprises deforming the gasket against the wall.

11. A method as claimed in claim 1, wherein contacting includes deflecting the cleat inward away from the wall.

12. A method as claimed in claim 1, wherein the cleat includes a beveled surface that facilitates insertion of the valve member into the housing and wherein contacting includes engaging the beveled surface with the outer edge of the side wall.

13. A liquid-dispensing container comprising:
a housing adapted to hold a liquid in an interior volume, the housing including an opening defined by an inner edge and an outer edge; and
a valve member having a ledge engaging the outer edge and a cleat spaced from the ledge and engaging the inner edge.

14. A liquid-dispensing container as claimed in claim 13, wherein the housing includes a battle and a separable cap.

15. A liquid-dispensing container as claimed in claim 13, wherein the inner and outer edges are defined by a wall and the valve member further includes an integral gasket positioned between the ledge and the cleat, the gasket being deformed in engagement with the wall.

16. A liquid-dispensing container as claimed in claim 13, wherein the cleat comprises a plurality of cleats circumferentially spaced from each other.

17. A liquid-dispensing container as claimed in claim 13, wherein the cleat includes a beveled surface that facilitates insertion of the valve member into the housing.

18. A liquid-dispensing container as claimed in claim 13, wherein the cleat is secured to a flexible leg to facilitate biased movement of the cleat away from the inner edge.
